(19) United States
(12) Patent Application Publication
(10) Pub. No.: US 2016/0368408 A1
(43) Pub. Date: Dec. 22, 2016

(54) Attachable Vehicle Handle System

(71) Applicant: John P. Magoolaghan, Southport, NC (US)

(72) Inventor: John P. Magoolaghan, Southport, NC (US)

(21) Appl. No.: 14/744,105

(22) Filed: Jun. 19, 2015

(51) Int. Cl. B60N 3/02; F16M 13/02

(52) U.S. Cl. CPC B60N 3/026; F16M 13/022

(57) ABSTRACT

An attachable handle includes a first support member and a first fastener attached to the first support member. The fastener is configured to removably attach to a first hinge of a vehicle door. In another example, a second support member may be attached to the first support member and may be used as a contact point, or handle, for lifting, pushing, and pulling. The first fastener may extend from the first support member and may interlock with a hinge of the door of a vehicle. A second fastener may extend and interlock with a second vehicle hinge.

### I. CLAIM OF PRIORITY

This application is a continuation patent application of and claims priority from, U.S. Provisional Patent Application Ser. No. 62/014,804, filed on Jun. 20, 2014, entitled, Attachable Vehicle Handle, which are incorporated by reference herein in its entirety for all purposes.

### II. FIELD OF THE DISCLOSURE

The disclosure relates to mechanical devices to assist a person with mobility, and more particularly, to a handle used to useful for situating a person into a vehicle.

### III. BACKGROUND

Getting into an automobile is a daunting and often dangerous task for people with mobility challenges. The elderly or handicapped may lack the strength or balance to safely seat or to exit an automobile. They consequently risk falling and injury. The exertion, anxiety, and actual danger associated with getting in and out of an automobile can limit their perceived freedom and quality of life.

### IV. SUMMARY OF THE DISCLOSURE

According to a particular embodiment, an attachable handle may include a first support member and a first fastener attached to the first support member. The first fastener may be configured to removably attach to a first hinge of a vehicle door.

The second fastener may be configured to attach to a second hinge of the vehicle door. A second support member may be attached to the first support member. The first fastener may include a hook mechanism. The first fastener may include a spring release mechanism. The first fastener may additionally include a damp mechanism. The first fastener may additionally include a handle portion attached to the first support member. A light may be configured to illuminate the first hinge.

A position of the first fastener may be configured to be adjusted relative to a length of the first support member. An orientation of the first fastener may be configured to be adjusted relative to a direction of a length of the first support member.

The first support member may include a first end and a second end. The first fastener may be positioned proximate the first end. The second end includes a prop structure configured to contact a surface of the vehicle.

At least one of the first fastener and the first support member may be adjustable to fit multiple hinge configuration of a plurality of vehicular models. The handle may include a padded surface and/or a securement pin. The first support member may be configured to accept a plurality of different fasteners selectable based on a model of the vehicle.

A portion of a plurality of different fasteners may be configured to be inserted inside a portion of the first support member. A release pin may extend in a substantially parallel orientation with respect to a portion of the support member. The release pin may be attached to the first support member and may contact a door of the vehicle.

According to a particular embodiment, a method of manufacturing an attachable handle may include configuring a first fastener to be removably attachable to a vehicle door. The first fastener may be attached to a first support member. A second support member may be attached to the first support member.

These and other advantages and features that characterize embodiments are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments.

### V. BRIEF DESCRIPTION OF THE DRAWINGS

FIG. 1 is a block diagram of an attachable handle in accordance with an embodiment;

FIG. 2 is a block diagram of a fastener configured to attach to the attachable handle of FIG. 1; and

FIG. 3 is a block diagram of an attackable handle in accordance with another embodiment.

### VI. DETAILED DESCRIPTION

As embodiment provides a readily attachable and detachable handle system for getting disabled, and elderly persons in and out of vehicle. The handle system may be configured to universally fit any automobile or light truck. The handle system may attach quickly and easily to one ox more door hinges of the vehicle. An embodiment includes a two-handed, front-facing design for unassisted personal movement. In so doing, the handle system restores mobility, confidence, and safety. The handle system may be used while a person is standing, seated, or in an intermediate position. The handle system provides support for pushing, pulling, lifting, and steadying. The attachment of the handle system to the hinge of the vehicle further prevents from the door from closing, keeping the door safely out of the way.

According to a particular embodiment an attachable handle includes a first support member having a first fastener, such as a hook. A second support member may be attached to the first support member and may be used as a contact point, or handle, for lifting, pushing, and pulling. The first fastener may extend from the first support member and may interlock with a first binge of the door of a vehicle. In another or the same embodiment, a second fastener may extend and interlock with a second vehicle hinge.

Where so configured, the orientation and relative positions of either fastener (as well as any associated clamping device) may be reversed, shifted, or otherwise modified (e.g., relative to the support member) to accommodate different vehicle hinge spacing configurations. For instance, the distance between the fasteners may be lengthened or shortened by a user.

The presence of the fastener wedged on the hinge may prevent the vehicle door from closing. This feature may provide additional stability and safety for a user. An illustrative fastener may include a hook attached to a clamping device. Other illustrative fasteners may include bolts, clamps, adhesives, hook and. loop fasteners, suction devices, male and female snaps, straps, rope, among virtually any device or material that can secure one object to another.

The fasteners may be slid over and/or under corresponding vehicle hinges. For example, the first fastener may engage the first hinge, and then once secure, the second fastener may be positioned to engage the second hinge.

During manufacture, the first fastener may be attached to the first support member. The second support member may be attached to the first support member. The second fastener may be attached to the first support member such that the second fastener exerts a force in an opposite direction to fee force exerted by the first fastener. A light by may be attached to the first support member in such a manner as to illuminate the first hinge in a nighttime scenario.

In operation, a user may attach the handle system by attaching one or more fasteners to corresponding hinges of a vehicle. A clamping device of a hinge may be adjusted to tighten an attachment. A user may then grasp the handle system to enjoy unassisted entry or exit from the vehicle. The handle system may fee detached from the vehicle hinges in reverse order before being slowed by the user or an attendant.

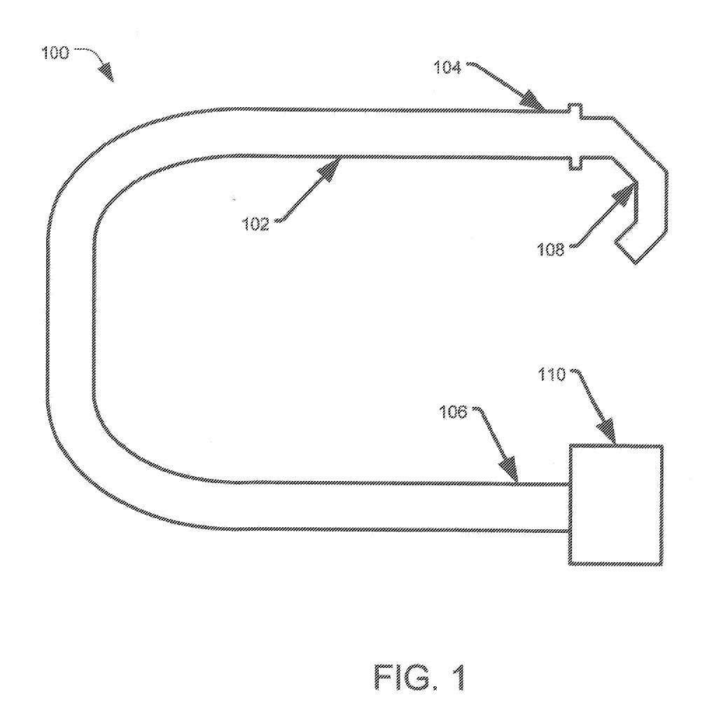

FIG. 1 is a block diagram of an attachable handle 100 in accordance with an embodiment. The handle includes a support member 102 having a first end 104 and a second end 106. The support member 102 may be constructed from a lightweight metal, ceramic, or plastic material, among other materials, not limited to wood and other organic materials. A fastener 108 may be attached to the support member 102. The fastener 108 may be configured to be attached to a hinge (not shown) of a car door. The fastener 108 may be interchangeable with other fasteners to interlock with door hinges of different vehicles. While the fastener 108 in FIG. 1 includes a particular hook shape, a suitable fastener may include other shapes and attaching mechanisms, as discussed herein.

The second end 106 of the support member 102 may be attached to a prop structure 110 configured to contact a surface of the vehicle. For example, the prop structure 110 may include a padded structure that braces the support member 102 against another hinge or in a gap formed between the door and a forward portion of the vehicle body. While the handle 100 of FIG. 1 includes a prop structure 110, a second end of another embodiment may include a second fastener configured to attach to a second binge of the door.

An embodiment may include a light, such as a bank of light emitting diodes (LEDs) that shine on the hinge to which the fastener 108 engages. The light may be adjustable to be directed onto the hinge and fastener 108. The fastener 108 may be adjustable in both vertical and horizontal directions to better engage the hinge. For example, the fastener 108 may include a pivot. Similarly, the prop structure 110 or a second fastener 106 attached to the second end 106 may include a pivot. Sections of the fasteners or support member may include padding or coatings to protect hinge and other vehicle surfaces.

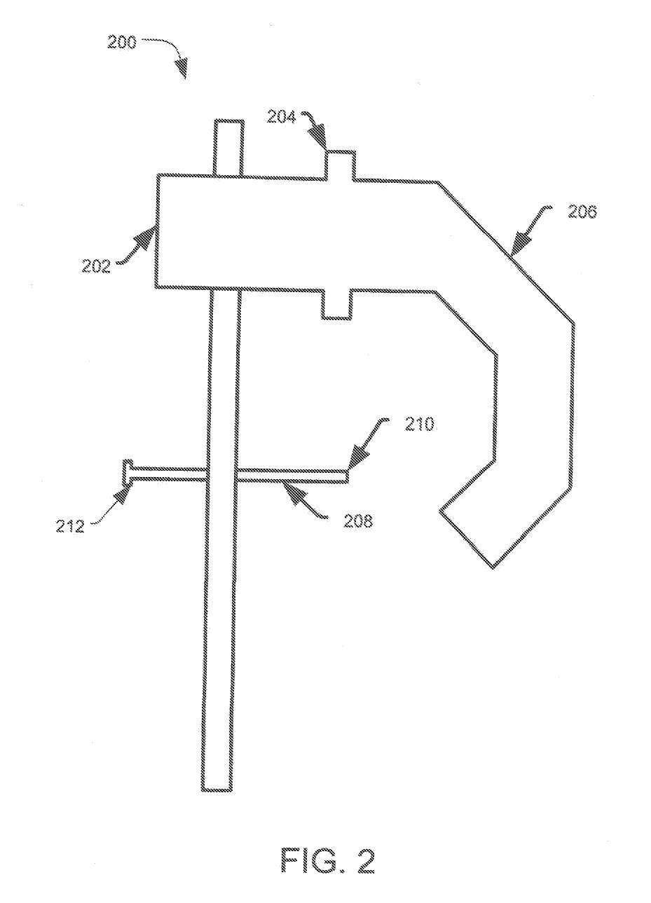

FIG. 2 is a block diagram of an interchangeable fastener 200 configured to attach to an attachable handle, such as the attachable handle 100 of FIG. 1. For instance, the fastener 200 may have a universal end 202 that fits in fits inside of the first end 104 of the attachable handle 100 of FIG. 1. Epoxy or a securing phi may be used to attach the universal end 202 inside of the handle. A hilt portion 204 may facilitate installation of the fastener 200 into the attachable handle. An engaging end 206 may include a hook or other attaching mechanism to interlock with the hinge of the vehicle door. The fastener 200 is interchangeable in that it may be one of a number of different fasteners having engaging ends of different lengths and shapes to accommodate different automobile hinge configurations.

A spring release mechanism 208 may extend in a direction that is substantially parallel to a portion of the engaging end 206. The spring release mechanism 208 may include a terminal end 210 that contacts a portion of the door, and a release end 212 that includes a button, switch, pin, or other release mechanism to retract the-spring release mechanism 206. The spring release mechanism 208 may further secure the attachment of the handle by providing additional support and locking leverage (e.g., upward forces preventing the disengagement of the fastener 200). For instance, the spring release mechanism 208 may contact a lower surface of the hinge, while the engaging end 206 hooks over and around atop portion of the hinge.

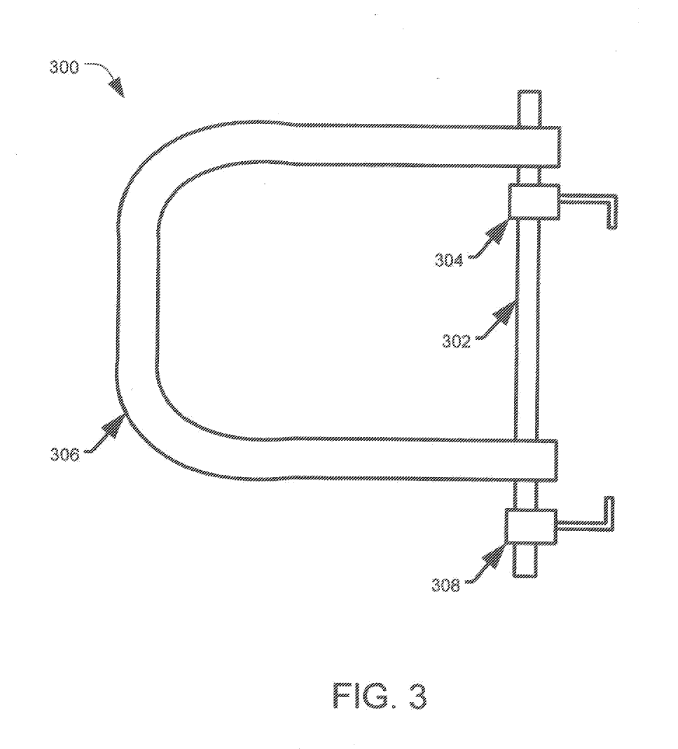

FIG. 3 is a block diagram of an attachable handle 300 in accordance with another embodiment. The attachable handle 300 includes a first support member 302 having a first fastener 304, such as a hook. A second support member 306 may be attached to the first support member 302 and may be used as a contact point, or handle, for lifting, pushing, and pulling. The first fastener 304 may extend from the first support member 302 and may interlock with a first binge of the door of a vehicle (not shown). In another or the same embodiment a second fastener 308 may extend and interlock with a second vehicle hinge.

Where so configured, the orientation and relative positions of either fastener 304, 308 may be reversed, shifted, or otherwise modified (e.g., relative to the first support member 302) to accommodate different vehicle hinge spacing configurations. For instance, the distance between the fasteners 304, 308 may be lengthened or shortened by a user. To this end, the fasteners 304, 308 may include clamp structures that may he loosened and retightened for adjustment. As above, suitable fasteners may include bolts, clamps, adhesives, hook and loop fasteners, suction devices, male and female snaps, straps, rope, among virtually any device or material that can secure one object to another

The presence of the fasteners 304, 308 wedged on the hinges may prevent the vehicle door from closing. This feature may provide additional stability and safety for a user. An illustrative fastener may include a hook attached to a clamping device.

The fasteners may be slide over and/or under corresponding vehicle hinges. For example, the first fastener may engage the first binge, and then once secure, the second fastener may be positioned to engage the second hinge.

Those skilled in the art may make numerous uses and modifications of and departures from the specific apparatus and techniques disclosed herein without departing from the inventive concepts. Consequently, the disclosed embodiments should be construed as embracing each and every novel feature and novel combination of features present in or possessed by the apparatus and techniques disclosed herein and limited only by the scope of the appended claims, and equivalents thereof.

1. An attachable handle, comprising:
a first support member baying a first end; and
a first fastener at the first end of the first support member, wherein the first fastener is configured to removably attach to a first hinge of a vehicle door.

2. The attachable handle of claim 1, further comprising a second fastener configured to attach to a second hinge of the vehicle door.

3. The attachable handle of claim 1, further comprising a second support member attached to the first support member.

4. The attachable handle of claim 1, wherein the first fastener includes a hook mechanism.

5. The attachable handle of claim 1, wherein the first fastener includes a spring release mechanism.

6. The attachable handle of claim 1, wherein the first fastener includes a clamp mechanism.

7. The attachable handle of claim 1, further comprising a handle portion attached to the first support member.

8. The attachable handle of claim 1, further comprising a light configured to illuminate the first hinge.

9. The attachable handle of claim 1, wherein a position of the first fastener is configured to be adjusted relative to a length of the first support member.

10. The attachable handle of claim 1, wherein an orientation of the first fastener is configured to be adjusted relative to a direction of a length of the first support member.

11. The attachable handle of claim 1, wherein the first support member includes a second end, where the second end includes a prop structure configured to contact a surface of the vehicle.

12. The attachable handle of claim 1, wherein at least one of the first fastener and the first support member is adjustable to fit multiple hinge configuration of a plurality of vehicular models.

13. The attachable handle of claim 1, further comprising a padded surface.

14. The attachable handle of claim 1, further comprising securement pin.

15. The attachable handle of claim 1, wherein the first support member is configured to accept a plurality of different fasteners selectable based on a model of the vehicle.

16. The attachable handle of claim 1, wherein a portion of the plurality of different fasteners are configured to be inserted inside a portion of the first support member.

17. The attachable handle of claim 1, further comprising a release pin extending in a substantially parallel orientation with respect to a portion of the support member.

18. The attachable handle of claim 17, wherein the release pin is attached to the first support member proximate the first hinge.

19. A method of manufacturing an attachable handle, the method comprising:
configuring a first fastener to be removably attachable to a vehicle door; and
attaching the first fastener to a first support member.

20. The method of claim 19, further comprising attaching a second support member to the first support member.
